(19) United States
(12) Patent Application Publication
(10) Pub. No.: US 2018/0061128 A1
(43) Pub. Date: Mar. 1, 2018

(54) Digital Content Rendering Coordination in Augmented Reality

(71) Applicant: Adobe Systems Incorporated, San Jose, CA (US)

(72) Inventors: Henricus Maria Cabanier, Seattle, WA (US); Yuyan Song, Milpitas, CA (US); Brian David Williams, San Jose, CA (US); Cory Lynn Edwards, Highland, UT (US); Byungmoon Kim, Sunnyvale, CA (US); Gavin Stuart Peter Miller, Los Altos, CA (US)

(73) Assignee: Adobe Systems Incorporated, San Jose, CA (US)

(21) Appl. No.: 15/244,656

(22) Filed: Aug. 23, 2016

(51) Int. Cl. G06T 19/00; G09G 5/12; G06F 3/14; G09G 5/14

(52) U.S. Cl. CPC G06T 19/006; G09G 5/12; G02B 27/017; G09G 5/14; G09G 2354/00; G06F 3/1423

(57) ABSTRACT

Digital content rendering coordination techniques in augmented reality are described. In one example, a user is provided with a first display device via which an augmented reality environment is to be viewed that includes at least a partial view of a physical environment. As part of this physical environment, a second display device (e.g., a desktop monitor, a mobile phone, and so forth) is also viewable by a user through the first display device, i.e., is directly viewable. Techniques are described herein in which a view of digital content on the second display device is coordinated with a display of digital content on the first display device. This may be used to support a variety of usage scenarios to expand and share functionality associated with these different devices.

### BACKGROUND

User interaction with computing devices is defined by the devices that are available to support this interaction, such as to provide inputs and view a result of these inputs. A user in a conventional desktop computer environment, for instance, is able to view a monitor placed on a surface having a fixed display size. The user may then interact with input devices such as a keyboards and cursor control device that are configured to provide specific types of inputs to the computer and view a result of this interaction on the monitor. Inputs provided via this technique are well suited to certain tasks, such as to provide a large number of inputs (e.g., typing) in an efficient manner. However, these inputs and resulting display caused by these inputs lack a natural feel of real world interaction of the user with a physical environment.

Accordingly, techniques have been developed to expand a richness in display and interaction with digital content. An example of this is augmented reality. In augmented reality, digital content (e.g., virtual objects) are used to augment a user's direct view of a physical environment in which the user is disposed. In other words, this direct view of the physical environment is not recreated as part of an augmented reality environment but rather the user actually “sees what is there.” The digital content, rather, is used to augment the user's view of this physical environment, such as to play a building game of virtual blocks on a physical table top.

Although an augmented reality environment may have support a wider variety of ways in which a user may view and interact with digital content over conventional techniques, this environment may suffer from a variety of limitations. In one such example, the augmented reality environment provides limited support for text entry, which is readily performed keyboards and cursor control devices as described above. This is because conventional techniques used to provide an augmented reality environment are typically divorced from conventional techniques used to interact with conventional computing devices as described above. Thus, interactions are provided separately from each other and are not able to efficiently leverage the separate strengths of these different environments.

### SUMMARY

Digital content rendering coordination techniques in augmented reality are described. In one example, a user is provided with a first display device via which an augmented reality environment is to be viewed that includes at least a partial view of a physical environment. As part of this physical environment, a second display device (e.g., a desktop monitor, a mobile phone, and so forth) is also viewable by a user through the first display device, i.e., is directly viewable. Techniques are described herein in which a view of digital content on the second display device is coordinated with a display of digital content on the first display device. This may be used to support a variety of usage scenarios to expand and share functionality associated with these different devices.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ coordination techniques described herein.

FIG. 2 depicts a system in an example implementation in which portions of digital content are coordinated for display by a plurality of display devices.

FIG. 3 depicts a system showing coordination of display of portions of the digital content on a display device of a computing device of FIG. 1 and a secondary display device of FIG. 2.

FIG. 4 depicts a system showing coordination of display of portions of digital content such that portions rendered in an augmented reality environment give context to a portion of digital content by the secondary display device.

FIG. 5 depicts a system in an example implementation in which an indication is used to indicate availability of an augmented reality environment usable to expand available interactions of the user with digital content.

FIG. 6 is a flow diagram depicting a procedure in an example implementation in which digital content is configured for coordination of portions of the content across a plurality of display devices as part of an augmented reality environment.

FIG. 7 is a flow diagram depicting a procedure in an example implementation in which rendering of portions of digital content is coordinated across a plurality of display devices as part of an augmented reality environment.

FIG. 8 illustrates an example system including various components of an example device that can be implemented as any type of computing device as described and/or utilize with reference to FIGS. 1-7 to implement embodiments of the techniques described herein.

### DETAILED DESCRIPTION

Overview

Augmented reality supports an ability to augment a user's view of a physical environment in which the user is disposed. This may be used to allow a user to play a game in which blocks appear on a surface of a table, monsters crawl down a wall in the user's living room, and so forth. As such, augmented reality may be used to expand both how a user views and interacts with digital content. Conventional techniques used to provide augmented reality environments, however, are typically provided as a standalone experience and thus may be limited by resolution of display devices, computational resources, and availability of input devices usable to interact with this environment.

Augmented reality digital content rendering coordination techniques and systems are described. These techniques and systems are configured to leverage functionality of additional devices in the provision of an augmented reality environment. In one example, a user is provided with a first display device via which an augmented reality environment is to be viewed, such as a head-mounted display. Through this head-mounted display, a user is able to view digital content and directly view a physical environment, e.g., walls, furniture, and other objects in a room in which the user is disposed.

As part of this physical environment, a second display device (e.g., a desktop monitor, a mobile phone, and so forth) is also viewable by a user through the first display device, i.e., is directly viewable. Techniques are described herein in which a view of digital content on the second display device is coordinated with a display of digital content on the first display device. In this way, digital content displayed on the first display device (e.g., the head-mounted display) may be used to augment digital content viewable on the second display device. This may be used to support a variety of usage scenarios.

In a first such scenario, an application is executed to cause output of a user interface. The user interface may then be portioned for display by both display devices. For example, menus, address bars, tools, and other chrome of the user interface may be displayed by the first display device (e.g., a head-mounted display) to augment a display of an item being worked on (e.g., digital image, spreadsheet, documents) using the second display device, e.g., a desktop monitor. Thus, the augmented reality environment may be used to expand what is available via the first display device for a single application, desktop of an operating system, and so on. This may also be used to leverage additional resources associated with the second display device, such as an increased resolution, associated computational resources of another computing device that is used to render the portion of digital content on the second display device, and so forth.

In a second such scenario, portions of digital content are used to give context to interaction with the digital content. A portion of a digital image, for instance, may be displayed on the second display device that is configured as a desktop monitor. Other portions of the digital image are then displayed “outside” of the desktop monitor through use of the first display device that supports augmented reality. This may be used to allow a user to efficiently navigate between portions of the digital image, view the digital image as having increased resolution on the first display device in comparison with the second display device, as well as interact with the second display device using input devices such as a keyboard and mouse, i.e., to “work on” the digital image. As a result, a user is provided with the best of both worlds including ease of interaction that is augmented using the augmented reality techniques.

In a third such scenario, a user may initially interact with the second display device, i.e., the desktop monitor. An indication is displayed by the second display device indicating availability of an augmented reality environment to expand a view of the second display device. The user, for instance, may interact with a digital image displayed on the desktop monitor. Upon selection of the indication, an expanded view of the digital image may appear in which the digital image is displayed as a plurality of layers, at least one of which is displayed “outside” of the second display device by the first display device. The layers, for instance, may appear as stacked in a “z” direction both in front of and in back of the second display device. A user may thus easily gain a context of the digital image, and select a particular layer with which the user wishes to interaction, e.g., via the second display device. A variety of other usage scenarios are also contemplated, further discussion of which is included in the following sections.

In the following discussion, an example environment is first described that may employ the techniques described herein. Example procedures are also described which may be performed in the example environment as well as other environments. Consequently, performance of the example procedures is not limited to the example environment and the example environment is not limited to performance of the example procedures.

Example Environment

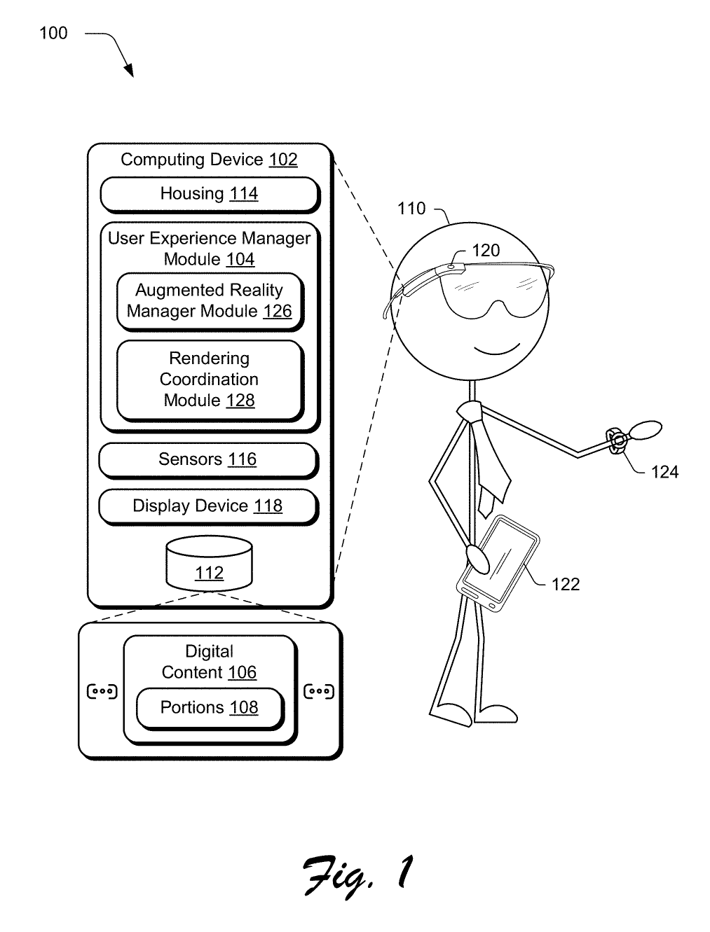

FIG. 1 is an illustration of a digital medium environment 100 in an example implementation that is operable to employ coordination techniques described herein. The illustrated environment 100 includes a computing device 102 configured for use in augmented reality scenario, which may be configured in a variety of ways.

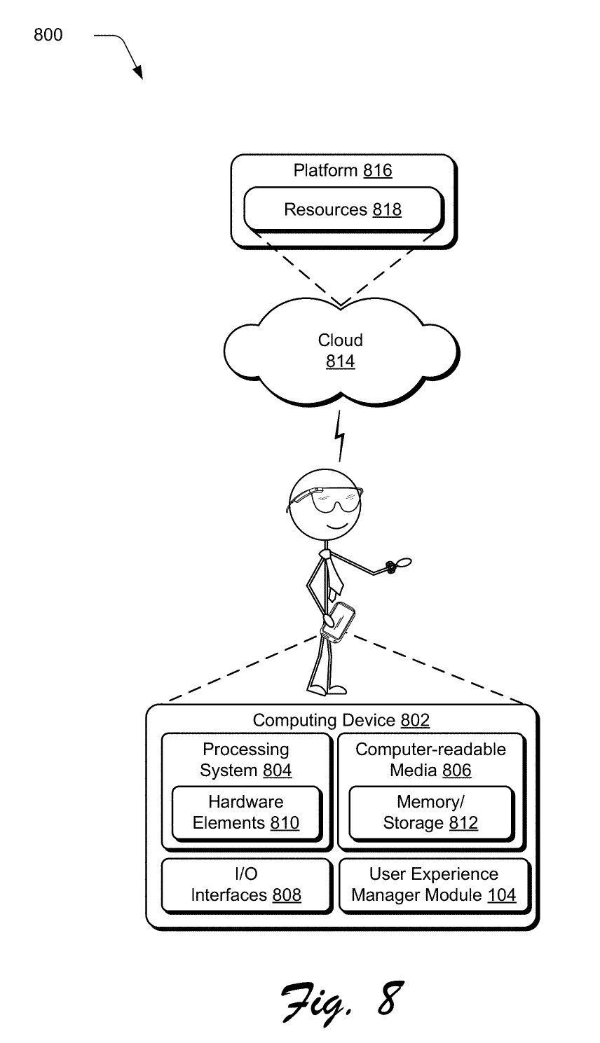

The computing device 102 is illustrated as including a user experience manager module 104 that is implemented at least partially in hardware of the computing device 102, e.g., a processing system and memory of the computing device as further described in relation to FIG. 8. The user experience manager module 104 is configured to manage output of and user interaction with digital content 106 and portions 108 of the digital content by a user 110. Examples of such digital content 106 include documents, spreadsheets, digital images, user interfaces of an application, slides of a presentation, a desktop of an operating system, multimedia, and so forth. The digital content 106 is illustrated as maintained in storage 112 of the computing device 102 but may be maintained elsewhere, such as “in the cloud” as also described in relation to FIG. 8.

The computing device 102 includes a housing 114, one or more sensors 116, and a display device 118. The housing 114 is configurable in a variety of ways to support interaction with the virtual user experience 106. In one example, the housing 114 is configured to be worn on the head of a user 110 (i.e., is “head mounted” 120), such as through configuration as goggles, glasses, contact lens, a projector that is configured to project directly to the eyes of the user 110, and so forth. In another example, the housing 114 assumes a hand-held 122 form factor, such as a mobile phone, tablet, portable gaming device, and so on. In yet another example, the housing 114 assumes a wearable 124 form factor that is configured to be worn by the user 110, such as a watch, broach, pendant, or ring. Other configurations are also contemplated, such as configurations in which the computing device 102 is disposed in a physical environment apart from the user 110, e.g., as a “smart mirror,” wall-mounted projector, television (e.g., a series of curved screens arranged in a semicircular fashion), and so on.

The sensors 116 may also be configured in a variety of ways to detect a variety of different conditions. In one example, the sensors 116 are configured to detect an orientation of the computing device 102 in three-dimensional space, such as through use of accelerometers, magnetometers, inertial devices, radar devices, and so forth. In another example, the sensors 116 are configured to detect environmental conditions of a physical environment in which the computing device 102 is disposed, such as objects, distances to the objects, motion, colors, and so forth. Examples of which include cameras, radar devices, light detection sensors (e.g., IR and UV sensors), time of flight cameras, structured light grid arrays, barometric pressure, altimeters, temperature gauges, compasses, geographic positioning systems (e.g., GPS), and so forth. In a further example, the sensors 116 are configured to detect environmental conditions involving the user 110, e.g., heart rate, temperature, movement, and other biometrics.

The display device 118 is also configurable in a variety of ways to support rendering of the digital content 106. Examples of which include a typical display device found on a mobile device such as a camera or tablet computer, a light field display for use on a head mounted display in which a user may see through portions of the display (e.g., as part of an augmented reality scenario), stereoscopic displays, projectors in which the digital content 106 is displayed on a surface or directly to an eye of the user 110, and so forth. Other hardware components may also be included as part of the computing device 102, including devices configured to provide user feedback such as haptic responses, sounds, physical input devices, and so forth.

The housing 114, sensors 116, and display device 118 are also configurable to support different types of virtual user experiences by the user experience manager module 104. The user experience manager module 104 is illustrated as supporting an augmented reality manager module 126. In augmented reality, virtual objects of digital content are used to augment a direct view of a physical environment of the user 110. The augmented reality manger module 126, for instance, may detect landmarks of the physical table disposed in the physical environment of the computing device 102 through use of the sensors 116, e.g., object recognition. Based on these landmarks, the augmented reality manager module 126 configures the virtual bricks to appear as is placed on the physical table when viewed using the display device 118.

The user 110, for instance, may view the actual physical environment through head-mounted 120 goggles. The head-mounted 120 goggles do not recreate portions of the physical environment as virtual representations as in a virtual reality scenario, but rather permit the user 110 to directly view the physical environment without recreating the environment. The virtual objects are then displayed by the display device 118 as part of an augmented reality environment to appear as disposed within this physical environment. Thus, in augmented reality the digital content 106 acts to augment what is “actually seen” by the user 110 in the physical environment.

The user experience manager module 104 is also illustrated as including a rendering coordination module 128. The rendering coordination module 128 is implemented at least partially in hardware of a computing device (e.g., computing device 102) to coordinate rendering of portions 108 of the digital content 106. In one example, this includes coordination of rendering of portions 108 of the digital content 106 on a display device that does not, itself, support augmented reality scenarios. Rather, the display device is incorporated within as directly viewable within a physical environment that is part of the augmented reality environment that is viewable via another display device. In this way, the augmented reality environment may be used to supplement what is displayed by the display device that does not support augmented reality.

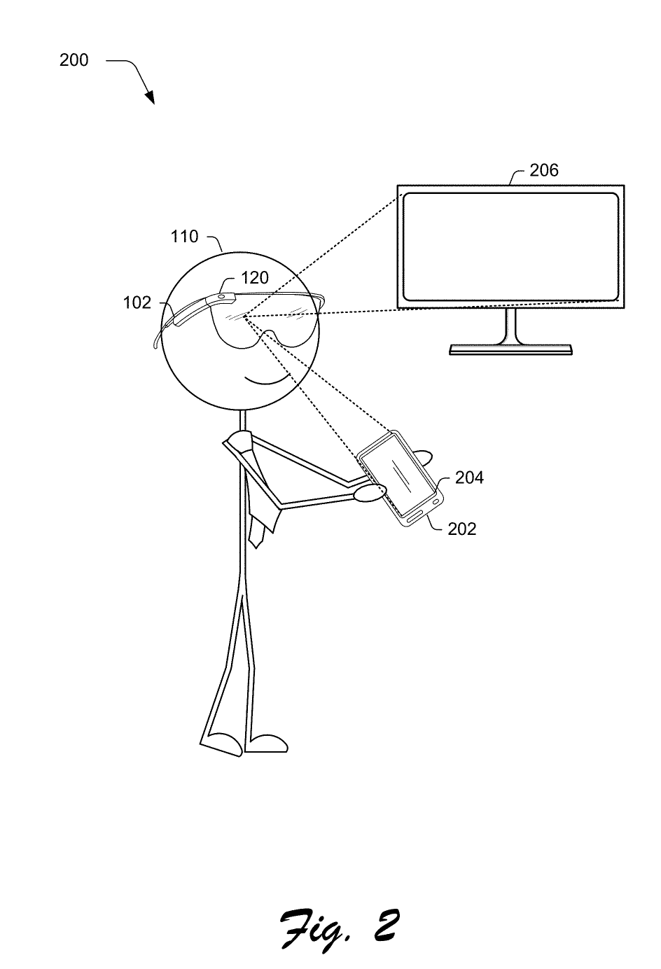

FIG. 2 depicts a system 200 in an example implementation in which portions 108 of the digital content 106 are coordinated for display by a plurality of display devices. In this example, the display device 118 of the computing device 102 is implemented as a head-mounted 120 goggles or other eyewear. Other examples are also contemplated, such as implemented as a projector as described above. This display device 118 is utilized by the augmented reality manager module 126 of FIG. 1 to render portions 108 of the digital content 106 in an augmented reality environment.

As previously described, an augmented reality environment is configured to give the user 110 a direct (e.g., unaltered, not recreated) view of at least part of a physical environment in which the user 110 is disposed. Part of this directly viewable physical environment includes additional display devices. A first example of this is illustrated as a second display device incorporated as part of a mobile computing device 202 (e.g., mobile phone, tablet, laptop, wearable, and so forth) that includes an integrated display device 204. Thus, in this example, the display device 204 of the mobile computing device 202 is part of another computing device that is separate from the computing device 102 in the head-mounted 120 goggles. This may be used to leverage resources of both computing devices as further described below.

In a second example, the secondary display device 206 is not incorporated as part of a separate computing device from the computing device 102. Rather, the secondary display device 206 is configured as an additional device, via which, the computing device 102 may render digital content 106. This secondary display device 206 is also directly viewable by the user 110 as part of the physical environment.

In both examples, the secondary display devices 204, 206 are used to render portions 108 of the digital content 106 that is supplemented by portions 108 of the digital content 106 of the display device 116 that supports an augmented reality environment. The user 110, for instance, may view the secondary display devices 204, 206 within a physical environment that is augmented by the display device 118 of the computing device 102. In this way, an augmented reality environment may be used to augment interaction with the secondary display devices 204, 206 within a physical environment of the user 110. This may support a variety of usage scenarios, examples of which are described in the following.

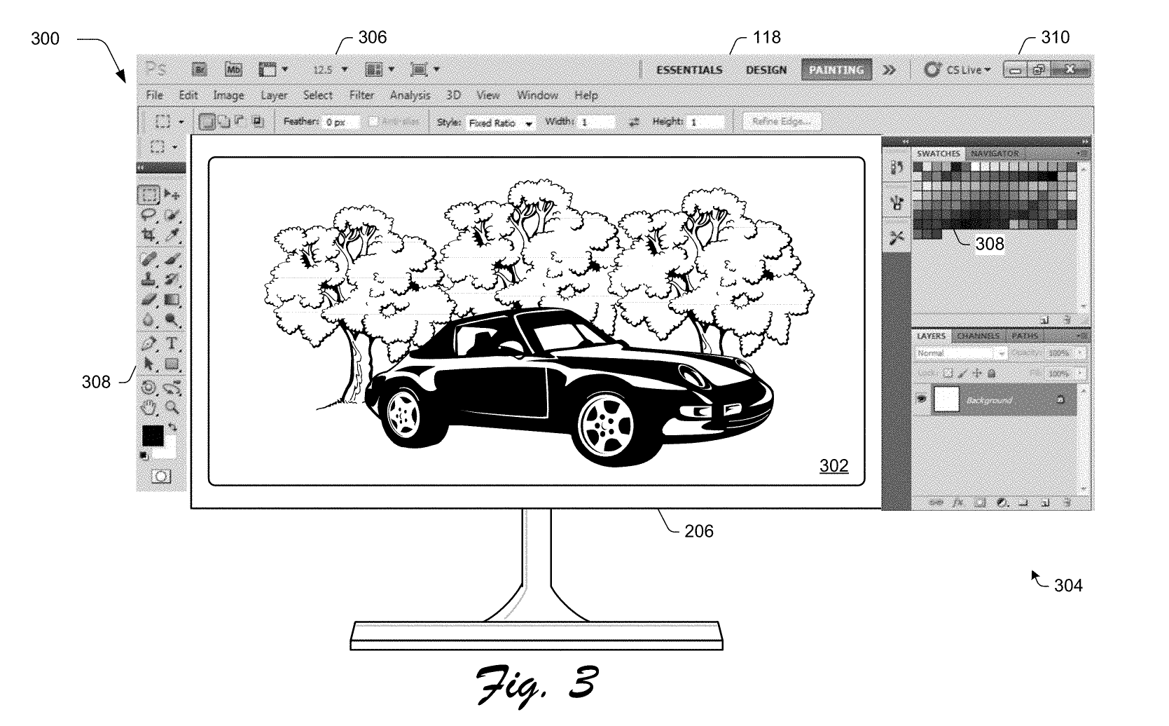

FIG. 3 depicts a system 300 showing coordination of display of portions 108 of the digital content 106 on the display device 118 of the computing device 102 and the secondary display device 206 of FIG. 2. In this example, a user interface of a single application is displayed by the display device 118 of the computing device 102 and the secondary display device 206. The application may be executed by the computing device 102 that is configured to support interaction with an augmented reality environment (i.e., has display device 118) or another computing device that is coupled to the secondary display device 206 e.g., a desktop computer, tablet, “in the cloud,” and so on.

Rendering of portions 108 of the digital content 106 of a user interface is coordinated by the rendering coordination module 128. As previously described in relation to FIG. 2, the secondary display device 206 is directly viewable by the user 110 as part of the physical environment “through” a display by the display device 118 of computing device 102. The secondary display device 206 thus defines a boundary within the augmented reality environment in which rendering of a respective portion of digital content is performed by that device. As a result, the secondary display device 206, and a display of the secondary display device 206, are not recreated, represented, or re-rendered, at least in part, by the display device 118. Thus, rendering of portions 108 of the digital content 106 by the secondary display device 206 may conserve computing resources that otherwise would be consumed by rendering of those portions 108 by the display device 118 as part of an augmented reality environment.

This may be used to leverage differences in capabilities by the display devices 118, 206, such as differences in resolution, to support partial transparency in the augmented reality environment and prevent “wash out” through use of the secondary display device 206, and so forth. This may also be used to leverage differences in capabilities of computational resources (e.g., processing and memory resources), such as greater processing resources of a desktop computer, mobile phone, or tablet associated with the secondary display device 206 than those available from a head-mounted configuration 120 of the computing device 102.

As shown in FIG. 3, for instance, a portion 302 of digital content of a user interface of an application that is configured to edit digital images is shown. The portion 302 includes a display of an item “being worked on”, e.g., a digital image in this example. Other portions 304 of the user interface of the application are displayed “outside” of the secondary display device 206 by the display device 118 as part of an augmented reality environment. Illustrated examples of which include a menu bar 306, representations of tools 308, chrome 310, layers, and so on. Selection of these representations as part of this portion 306 of the user interface are then used to initiate operations used to transform the item being worked on, e.g., the digital image as the portion displayed by the secondary display device 206.

In this way, differences available for viewing and interaction supported by the different display devices 118, 206 may be leveraged. Display of the portion 302 of the secondary display device 206, for instance, may leverage increased resolution and responsiveness, lack of “ghosting” and “washout,” as well as computational resources of a computing device associated with this display. Portions 304 of the digital content of the user interface of the application may then be used to supplement this view by including user interface controls outside of this view. This may be used to take advantage of an expanded display area (e.g., a greater angular amount of view that is available to the user 110 for display device 118 than display device 206), leverage partial transparency to enable a user to view a physical environment at least partially through this portion 304, and so forth.

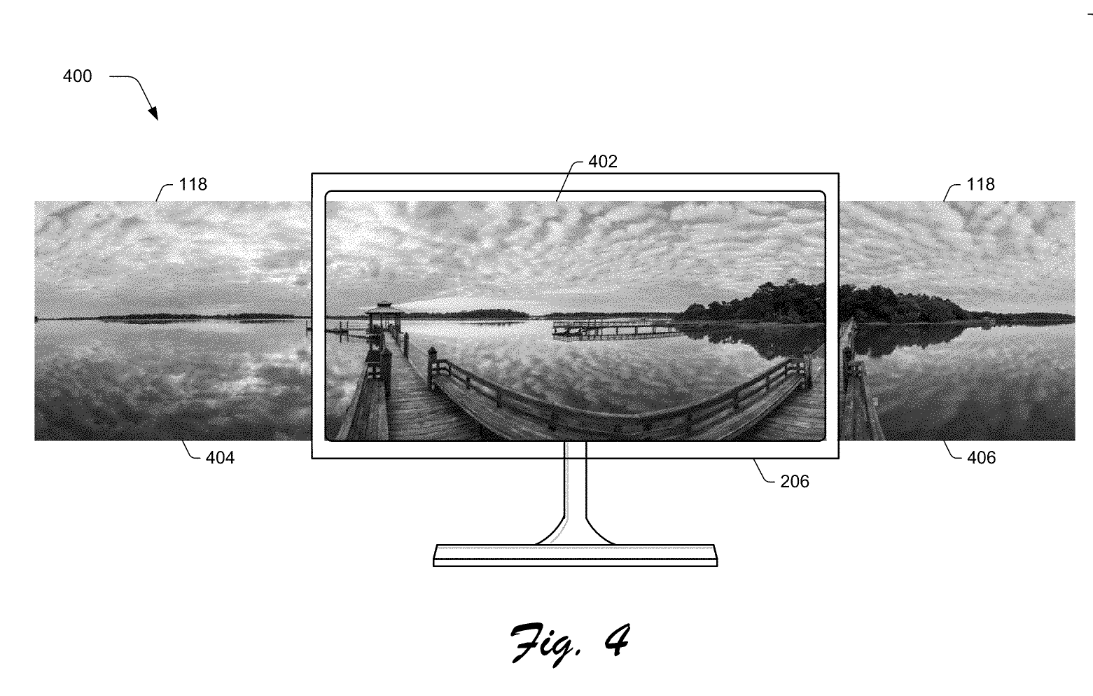

FIG. 4 depicts a system 400 showing coordination of display of portions 108 of the digital content 106 such that portions rendered in an augmented reality environment is used to give context to a portion of digital content by the secondary display device 206. In this example, a single digital image (e.g., a frame of a video) is segmented into a plurality of portions. A first portion 402 is displayed by the secondary display device 206. As with the previous examples, this may correspond to the portion 402 “being worked on” by a creative professional.

Other portions 404, 406 of this single digital image are displayed using the display device 118 of computing device 118 as virtual objects disposed “outside” of a housing of the secondary display device 206. Accordingly, these other portions 404, 406 may be used to give a navigation context to “where” the portion 402 displayed by the secondary display device 206 is disposed in relation to an entirety of the digital content as a whole.

In this way, a user may readily interact with the second display device 206 and input functionality associated with that device (e.g., a keyboard and cursor control device) to navigate to different portions of the single digital image. As part of this, the user 110 is given context through other portions displayed in an augmented reality environment to efficiently navigate through this content. A variety of other examples are also contemplated, such as engineering drawings, owner's manual, and other scenarios is which the digital content is not readily viewable by a conventional display device “all at one time” without support of an augmented reality environment.

In another example, full resolution of the secondary display device 206 may be used in its entirety, i.e., “all the way to its edge,” at which point the resolution may transition to the resolution of display device 118, e.g., the “goggles.” This may support a variety of usage scenarios, such as for reading documents. In a further example, the digital content 106 may be selectively defocused near the edges of the secondary display device 206. This may be used to provide a smooth transition to the visual resolution of the display device 118, thus helping the seam to “disappear” to the user 110. This may find particular usefulness when viewing a large natural image that spills over the edge of the secondary display device 206.

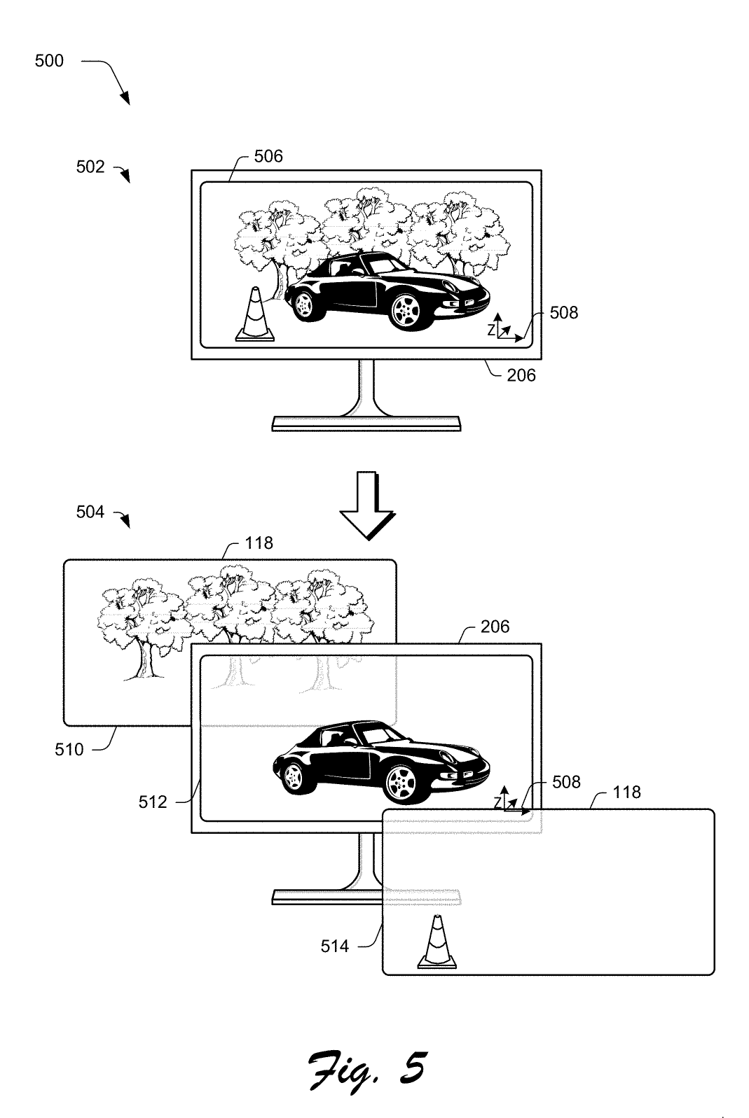

FIG. 5 depicts a system 500 in an example implementation in which an indication is used to indicate availability of an augmented reality environment usable to expand available interactions of the user 110 with digital content. This system 500 is illustrated using first and second stages 502, 504.

At the first stage 502, digital content 506 configured as a single digital image is displayed by the secondary display device 206, such as in a scenario in which the user 110 is editing the image. An indication 508 is used to indicate availability of an expanded view. The user 110 may then select this indication 508 (e.g., using a cursor control device, spoken utterance, keyboard) to cause output of the expanded view that leverages an augmented reality environment.

An example of this is shown at the second stage 504. Portions of the digital image are configured as layers 510, 512, 514 that are displayed in a stacked arrangement in a z-direction. Layers 510, 514 are displayed to appear behind and in front of the secondary display device 206 through use of augmented reality by the display device 118 of the computing device 102, e.g., a head-mounted 120 configuration of the computing device 102. The secondary display device 206 is used to display layer 512 as a portion of the digital content. As such, the user is made aware of which objects in the digital image are included in particular layers.

The user may then navigate between layers to select a particular layer of interest for transformation through interaction with the secondary display device 206. The user 110, for instance, may perform a gesture that is recognized by the computing device 102 as selecting a particular one of the layers. The computing device 102 may then communicate with another computing device that controls rendering by the secondary display device 206, e.g., a desktop computer, a cloud service, and so forth. This communication may cause the secondary display device 206 to initiate an operation, which in this case is to output to selected layer for editing by the user. In this way, interaction corresponding with display device 118 may be coordinated with interaction corresponding with the secondary display device 206 to expand a variety of interactions that are available to the user 110 via respective devices.

In another example, two or more users 110 may simultaneously interact with such a system. In one scenario, the two users could view the secondary display device 206 simultaneously, but only one of the users 110 is able to view the display device 118, e.g., is wearing the head mounted 120 goggles. In this scenario, portions 514, 510 of the digital content 106 may be used to annotate the portions 512 of the digital content displayed by the secondary display device 206, as an overlay, in a layer above or behind the secondary display device 206 as illustrated, in the periphery as shown in FIG. 4, and so forth. One example of such a use involves two users editing a document, with one able to see some comments that the other could not, or a teacher, with some additional hint annotations not visible to the student.

In another scenario, where both users wear 110 the display device 118, the secondary display device 206 could be shared, but the surrounding elements would be different for each participant. For example, each of the users 110 may be able to separately drag those assets onto the secondary display device 206 to share them with the other users that are present. Techniques may also be incorporated for color accuracy between the devices, such as to use sensors of computing device 102 to ensure that colors are accurately reproduced by both display devices 117, 206. Further discussion of these and other examples is included in the following section.

Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-5.

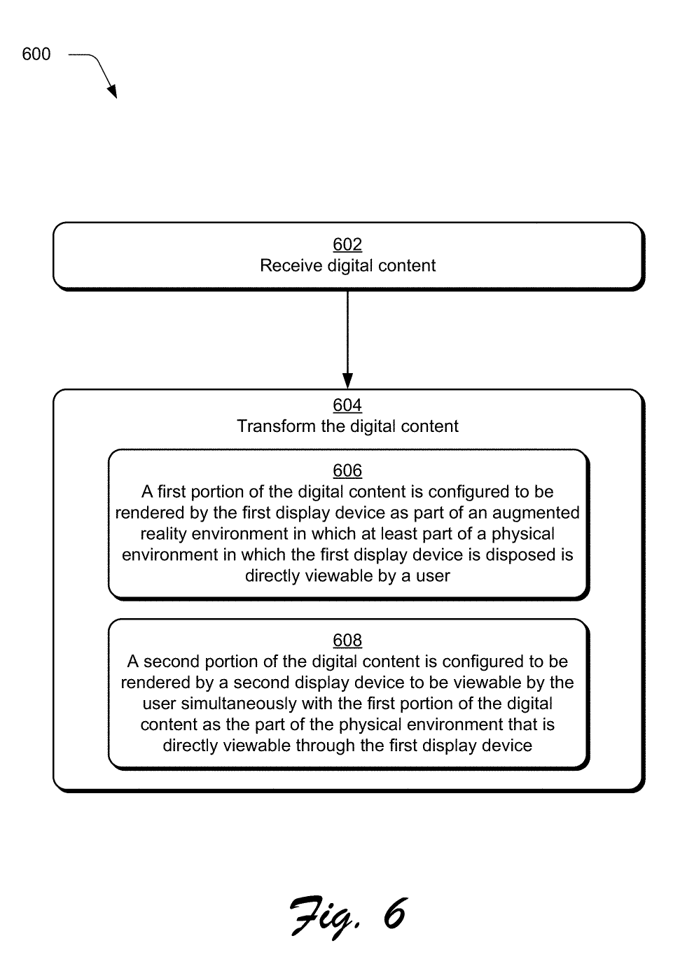

FIG. 6 depicts a procedure 600 in an example implementation in which digital content is configured for coordination of portions of the content across a plurality of display devices as part of an augmented reality environment. Digital content is received (block 602). The computing device 102 of FIG. 1, for instance, may receive a user interface, digital image, video, multimedia, or any other configuration of digital content. In another instance, a service provider of a web service may include functionality to configure the digital content via a network.

The digital content is then transformed (block 604) by the computing device. This includes configuring a first portion of the digital content to be rendered by a first display device as part of an augmented reality environment in which at least part of a physical environment in which the first display device is disposed as directly viewable by a user (block 606). A second portion of the digital content is configured to be rendered by a second display device to be viewable by the user simultaneously with the first portion of the digital content as the part of the physical environment that is directly viewable through the first display device (block 608).

The rendering coordination module 128, for instance, may transform the digital content 106 to explicitly specify which portions 108 of the digital content 106 are to be rendered by respective ones of the display devices. This may be performed by associating metadata with the digital content 106 through use of headers, associated files (e.g., a manifest), and so forth. In this way, a creator of the digital content 106 may specify how the portions 108 of the digital content may take advantage of an augmented reality environment as previously described.

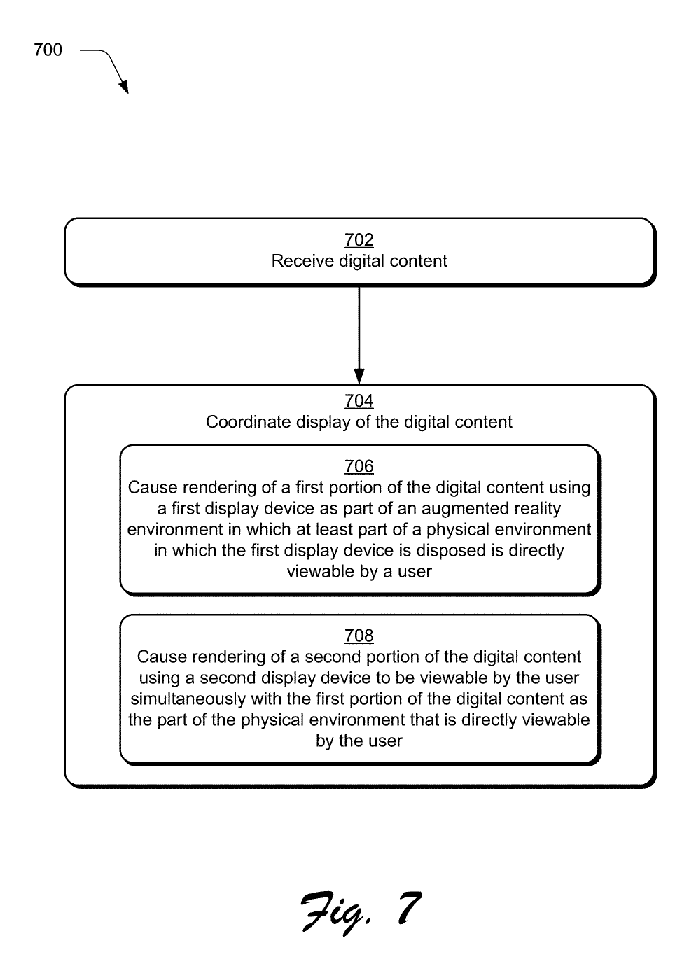

FIG. 7 depicts a procedure 700 in an example implementation in which rendering of portions of digital content is coordinated across a plurality of display devices as part of an augmented reality environment. The digital content is received (block 702) and display of the digital content is coordinated (block 704). The rendering coordination module 128, for instance, may be incorporated as part of an application, a media viewer, an operating system, and so forth. Additionally, the digital content 106 may be received from storage 112 local to the computing device 102 and/or remotely via a network.

This includes causing rendering of a first portion of the digital content using a first display device as part of an augmented reality environment in which at least part of a physical environment in which the first display device is disposed is directly viewable by a user (block 706), e.g., the display device 118. This also includes causing rendering of a second portion of the digital content using a second display device to be viewable by the user simultaneously with the first portion of the digital content as the part of the physical environment that is directly viewable by the user (block 708), e.g., the secondary display devices 204, 206. This process may continue, such as transform a third portion of the digital content is configured to be rendered by a third display device to be viewable by the user simultaneously with the first portion of the digital content and not the second portion of the digital content. For example, the first and third display devices may be worn by different users, e.g., goggles, such that these users are able to view different portions of the digital content. This may be used to support a variety of usage scenarios, examples of which are described in relation to FIGS. 3-5.

Example System and Device

FIG. 8 illustrates an example system generally at 800 that includes an example computing device 802 that is representative of one or more computing systems and/or devices that may implement the various techniques described herein. This is illustrated through inclusion of the user experience manager module 104. The computing device 802 may be, for example, a server of a service provider, a device associated with a client (e.g., a client device), an on-chip system, and/or any other suitable computing device or computing system. Thus, operations performed by the rendering coordination module 128 may be implemented locally or remotely, in whole or in part.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. In a digital medium environment to control display of digital content, a method implemented by at least one computing device, the method comprising:
receiving, by the at least one computing device, the digital content; and
coordinating, by the at least one computing device, display of the digital content by:
causing rendering of a first portion of the digital content using two augmented reality display devices as part of an augmented reality environment in which at least part of a physical environment in which the two augmented reality display devices are disposed is directly viewable by two or more users of the two augmented reality display devices, the first portion of the digital content being different for the two or more users; and
causing rendering of a second portion of the digital content using an additional display device to be viewable by the two or more users simultaneously with the first portion of the digital content as the part of the physical environment that is directly viewable by the two or more users, the second portion of the digital content being shared by the two or more users on the additional display device.

2. The method as described in claim 1, wherein the part of the physical environment is directly viewable such that the part is not rendered by the two augmented reality display devices.

3. The method as described in claim 1, wherein the part of the physical environment that is directly viewable includes the second portion of the digital content of the additional display device.

4. (canceled)

5. The method as described in claim 1, wherein the digital content includes metadata specifying the first portion of the digital content to be rendered by the two augmented reality display devices and the second portion of the digital content to be rendered by the additional display device.

6. The method as described in claim 1, wherein the digital content is a user interface of a single application.

7. The method as described in claim 6, wherein coordinating the display of the digital content further includes:
causing a rendering of a third portion of the digital content including a menu bar, representations of a tool, or chrome of the user interface of the application, and wherein the first or the second portion of the digital content is selectable to which one or more operations are to be applied using the menu bar, representations of the tool, or chrome through execution of the application.

8. (canceled)

9. The method as described in claim 1, wherein the first portion of the item of digital content further provides a navigation context within a user interface to the second portion of the item of digital content.

10. The method as described in claim 1, further comprising:
receiving, by the at least one computing device, an input involving selection of an indication displayed by the additional display device; and
responsive to the receiving, initiating the coordinating of the display of the digital content.

11. The method as described in claim 1, wherein the first portion of the digital content is viewed as disposed over at least part of the second portion of the digital content.

12. In a digital medium environment to control display of digital content, a system comprising:
a first display device configured to support an augmented reality environment;
a second display device; and
a rendering coordination module implemented at least partially in hardware of a computing device, the rendering coordination module configured to control display of the digital content such that:
a first portion of the digital content is rendered using the first display device as part of the augmented reality environment in which at least part of a physical environment in which the first display device is disposed is directly viewable by a user, the first portion of the digital content being a first layer of multiple layers of a digital image; and
a second portion of the digital content is rendered using the second display device to be viewable by the user simultaneously with the first portion of the digital content through the augmented reality environment of the first display device, the second portion of the digital content being a second layer of the multiple layers of the digital image, the second layer of the multiple layers of the digital image rendered in a stacked arrangement in a z-direction relative to an orientation of the first display device.

13. The system as described in claim 12, wherein the first display device is configured to be head mounted and worn by the user and the second display device is incorporated as part of a mobile phone, tablet computer, desktop monitor, wearable computing device, or television.

14. The system as described in claim 12, wherein the first display device is configured to be at least partially transparent such that the part of the physical environment is directly viewable by the user through the display device and the second display device is not.

15. The system as described in claim 12, wherein the first display device is configured as a light guide or projector and the second display device is not.

16. The system as described in claim 12, wherein:
the second display device has a housing that defines a boundary, within which, the second portion of the digital content is rendered; and
the first display device is configured to render the first portion of the digital content as viewable outside of the boundary.

17. In a digital medium environment to configure digital content for display by first and second display devices, a method implemented by at least one computing device, the method comprising:
receiving, by the at least one computing device, the digital content; and
transforming, by the at least one computing device, the digital content such that:
a first portion of the digital content is configured to be rendered by the first display device as part of an augmented reality environment in which at least part of a physical environment in which the first display device is disposed is directly viewable by a user; and
a second portion of the digital content is configured to be rendered by the second display device to be viewable by the user simultaneously with the first portion of the digital content as the part of the physical environment that is directly viewable through the first display device, the second portion of the digital content selected for display by the second display device based on a difference in resolution between the first display device and the second display device, the transforming reducing computing resources by the first display device that would be consumed by the first computing device rendering the second portion of digital content in the augmented reality environment.

18. (canceled)

19. The method as described in claim 17, wherein the first and second portions of the digital content form a single frame of video and the metadata is specified using a header of the frame.

20. The method as described in claim 17, wherein the transforming includes a third portion of the digital content is configured to be rendered by a third display device to be viewable by the user simultaneously with the first portion of the digital content and not the second portion of the digital content.

21. (canceled)

22. (canceled)

23. (canceled)

24. The system as described in claim 12, wherein the rendering coordination module is configured to control the display of the digital content responsive to selection of an indication of an expanded view.

25. The system as described in claim 12, wherein rendering the second layer of the multiple layers of the digital image in the z-direction relative to the orientation of the first display device further comprises causing the second layer to appear behind or in front of the first display device.

26. The method as described in claim 17, wherein the second display device has a higher resolution than the first display device.
